(19) United States
(12) Patent Application Publication
(10) Pub. No.: US 2025/0180964 A1
(43) Pub. Date: Jun. 5, 2025

(54) CAMERA MODULE

(71) Applicant: SAMSUNG ELECTRO-MECHANICS CO., LTD., Suwon-si (KR)

(72) Inventors: Nam Ki PARK, Suwon-si (KR); Ji Buem CHUN, Suwon-si (KR); Jae Hyung HAN, Suwon-si (KR); Jong Woo HONG, Suwon-si (KR)

(73) Assignee: SAMSUNG ELECTRO-MECHANICS CO., LTD., Suwon-si (KR)

(21) Appl. No.: 18/645,707

(22) Filed: Apr. 25, 2024

(30) Foreign Application Priority Data
Nov. 30, 2023 (KR) 10-2023-0171582

(51) Int. Cl. G03B 5/00; G02B 27/64

(52) U.S. Cl. CPC G03B 5/00; G02B 27/646; G03B 2205/0069

(57) ABSTRACT

A camera module includes a carrier disposed in a housing; an optical module disposed on the carrier; a first driving unit including a first magnet coupled to the carrier, and a first coil; a second driving unit including one or more magnets coupled to the optical module, and a plurality of coils; a first ball group and a second ball group disposed between the carrier and the housing; and a substrate on which the first coil and the plurality of coils are disposed, wherein one of the coils faces one polarity of the one or more magnets, the other of the coils faces two polarities of the one or more magnets, the first ball group includes two or more balls, the second ball group includes fewer balls than the first ball group, and the substrate is mounted on two side surfaces of the housing to surround the second ball group.

### CROSS-REFERENCE TO RELATED APPLICATIONS

This application claims the benefit under 35 USC § 119 (a) of Korean Patent Application No. 10-2023-0171582 filed on Nov. 30, 2023, in the Korean Intellectual Property Office, the entire disclosure of which is incorporated herein by reference for all purposes.

### BACKGROUND

### 1. Field

The following description relates to a camera module.

### 2. Description of the Background

Camera module are implemented in portable electronic device such as, but not limited to, smartphones, tablet personal computers (PCs), and laptops. As the size of mobile communication terminals decrease, image quality may deteriorate since the size of the mobile communication terminals may greatly affect hand-shake or shaking of a device while imaging.

Image stabilization may be implemented by moving a lens module in a direction perpendicular to an optical axis with respect to an image sensor, or by moving an image sensor in a direction perpendicular to the optical axis with respect to the lens module.

For image stabilization, as a lens module or an image sensor may need to move along two mutually perpendicular axes, a driving unit may be necessary to generate driving force in a direction of each axis. Accordingly, a camera module having an image stabilization function may have an increased size.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing, a carrier disposed in the housing; an optical module disposed on the carrier; a first driving unit comprising a first magnet coupled to the carrier, and a first coil disposed to face the first magnet; a second driving unit comprising one or more magnets coupled to a first side surface of the optical module, and a plurality of coils disposed to face the one or more magnets; a first ball group and a second ball group disposed between the carrier and the housing, and spaced apart from each other in a first axis direction perpendicular to an optical axis direction; and a substrate on which the first coil and the plurality of coils are disposed, wherein a first of the plurality of coils faces one polarity of the one or more magnets, and a second of the plurality of coils faces two polarities of the one or more magnets, wherein the first ball group comprises two or more balls disposed in the optical axis direction, and the second ball group comprises fewer balls than the first ball group, and wherein the substrate is mounted on two side surfaces of the housing to surround the second ball group.

One surface of the one or more magnets which face an internal side surface of the substrate on which the plurality of coils are disposed has an N-pole and an S-pole, and wherein the N-pole and the S-pole are disposed in a second axis direction perpendicular to both the optical axis direction and the first axis direction.

A size of an area occupied by the N-pole may be different from a size of an area occupied by the S-pole on the one surface of the one or more magnets.

A first position sensor that faces the N-pole and a second position sensor that at least partially faces the N-pole and the S-pole may be disposed on the substrate.

The first position sensor may include one Hall sensor and the second position sensor may include a plurality of Hall sensors.

The one or more magnets may include a second magnet and a third magnet spaced apart from each other in a second axis direction perpendicular to the optical axis direction and the first axis direction, and the plurality of coils may include a second coil and a third coil spaced apart from each other in the second axis direction.

A length of the second magnet in the second axis direction may be greater than a length of the third magnet in the second axis direction.

A first surface of the second magnet may have one of an N-pole and an S-pole, and a first surface of the third magnet may have an opposite polarity to a polarity of the first surface of the second magnet.

The second coil may face the first surface of the second magnet, and one portion of the third coil may face the first surface of the second magnet, and another portion of the third coil may face the first surface of the third magnet.

A first surface of the second magnet may have a first polarity, and a first surface of the third magnet may have a second polarity and a first polarity in the second axis direction, and the first polarity and the second polarity may be opposite polarities.

A first position sensor that faces the first polarity of the second magnet and a second position sensor that at least partially faces the first polarity and the second polarity of the third magnet are disposed on the substrate, and the first position sensor may include one Hall sensor, and the second position sensor may include a plurality of Hall sensors.

A first position sensor that faces the first polarity of the second magnet and a second position sensor that at least partially faces the first polarity of the second magnet and the second polarity of the third magnet may be disposed on the substrate, and the first position sensor may include one Hall sensor, and the second position sensor may include a plurality of Hall sensors.

One of the plurality of coils and the one or more magnets may be configured to generate a driving force in a direction in which the one of the plurality of coils and the one or more magnets face each other, and another one of the plurality of coils and the one or more magnets may be configured to generate a driving force in a direction perpendicular to the direction in which the other of the plurality of coils and the one or more magnets face each other.

The camera module may further include a pulling magnet coupled to a second side surface of the optical module; a first yoke that faces the one or more magnets in the optical axis direction; and a second yoke that faces the pulling magnet in the optical axis direction.

In a general aspect, a camera module includes a housing; a carrier disposed in the housing; a substrate disposed in the carrier; an optical module disposed on the carrier; a first driving unit comprising a first magnet coupled to the carrier, and a first coil disposed to face the first magnet; a second driving unit comprising a second magnet and a third magnet coupled to a first side surface of the optical module, and a second coil and a third coil coupled to a first side of the substrate, and disposed to face the second magnet and the third magnet respectively; a first position sensor, coupled to a second side of the substrate, and disposed to face the first magnet, and a second position sensor and a third position sensor coupled to the first side of the substrate, and disposed to face the second magnet and the third magnet, wherein the first driving unit is configured to move the optical module in an optical axis direction, and wherein the second driving unit is configured to move the optical module in a first direction perpendicular to the optical axis direction and a second direction perpendicular to the optical axis direction and the first direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of an example camera module, in accordance with one or more embodiments.

FIG. 3 illustrates a carrier, in accordance with one or more embodiments.

FIG. 4 illustrates a perspective view and an enlarged view of a housing, in accordance with one or more embodiments.

FIG. 5 illustrates a perspective view of a substrate, in accordance with one or more embodiments.

FIG. 6 illustrates a second driving unit.

FIG. 7, FIG. 8, and FIG. 9 illustrate modified examples of a second driving unit.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more examples relate to a camera module which may be mounted on portable electronic devices such as, but not limited to, a mobile communication terminal, a smartphone, and a tablet PC.

One or more examples may provide a camera module which has an image stabilization operation, and may have a reduced size.

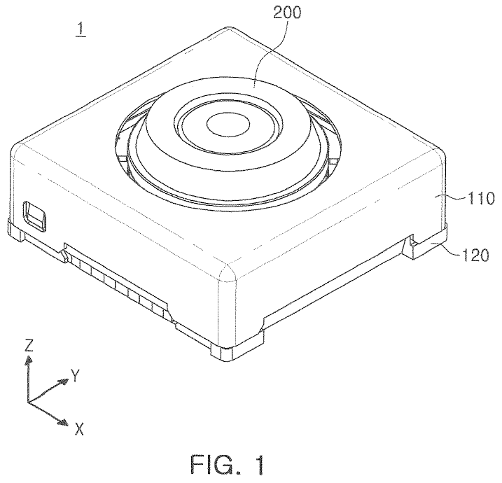

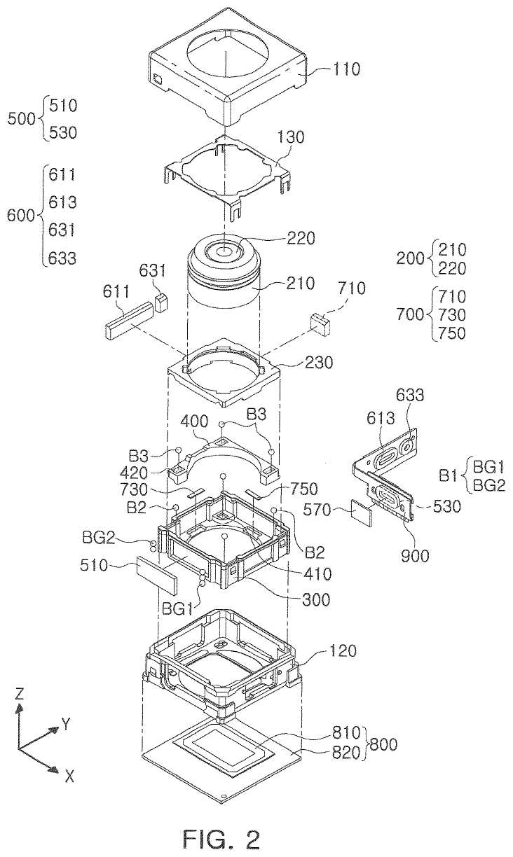

FIG. 1 illustrates a perspective diagram of an example camera module, in accordance with one or more embodiments. FIG. 2 illustrates an exploded perspective diagram of an example camera module, in accordance with one or more embodiments.

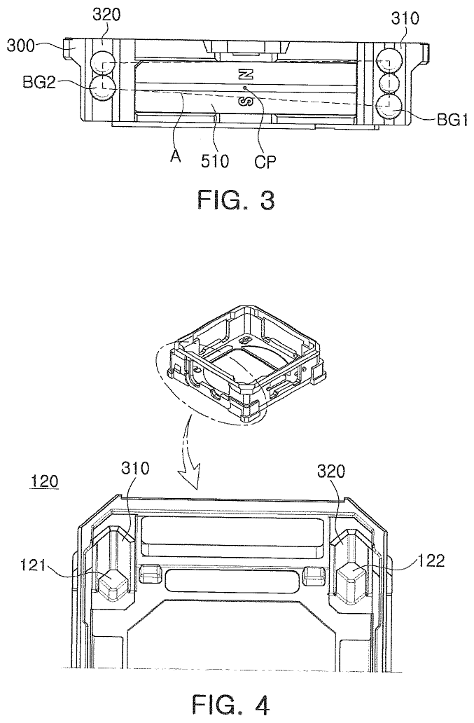

FIG. 3 illustrates a carrier, in accordance with one or more embodiments. FIG. 4 illustrates a perspective view and an enlarged diagram illustrating a housing, in accordance with one or more embodiments.

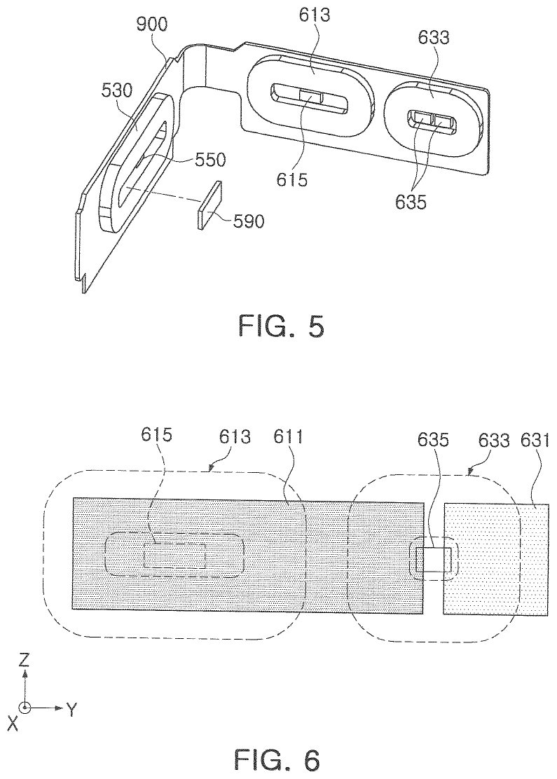

FIG. 5 illustrates a perspective view of a substrate, in accordance with one or more embodiments. FIG. 6 illustrates a second driving unit.

Referring to FIGS. 1 and 2, an example camera module 1, in accordance with one or more embodiments may include an optical module 200 and a housing 120.

In an embodiment, the optical module 200 may refer to a lens module. In another embodiment, the optical module 200 may refer to an image sensor module. Hereinafter, the description will be described with respect to an embodiment in which the optical module 200 is implemented as a lens module.

The optical module 200 may include a plurality of lenses 220 and a lens barrel 210 accommodating the plurality of lenses 220.

The lens barrel 210 may have a hollow cylindrical shape such that the plurality of lenses 220 may be accommodated therein, and the plurality of lenses may be accommodated in the lens barrel 210 along an optical axis.

In the one or more examples, the optical axis direction may refer to a direction that extends along the optical axis (Z-axis) of the optical module 200 upwardly and downwardly or a direction parallel to the optical axis (Z-axis).

The first axis (X-axis) direction may refer to a direction perpendicular to the optical axis (Z-axis) direction, and the second axis (Y-axis) direction may refer to a direction perpendicular to both the optical axis (Z-axis) direction and the first axis (X-axis) direction.

The optical module 200 may move in the optical axis (Z-axis) direction in the housing 120.

The camera module 1 may further include a carrier 300 and an image sensor module 800.

The carrier 300 may be disposed in the housing 120 and may move relative to the housing 120 in the optical axis (Z-axis) direction.

Each of an upper portion and a lower portion of the housing 120 may have an open shape or area, the carrier 300 may be disposed in an internal space of the housing 120, and the optical module 200 may be accommodated in the carrier 300.

The carrier 300 and the optical module 200 may move together in the optical axis (Z-axis) direction. Accordingly, a distance between the optical module 200 and the image sensor 810 may change to adjust a focus.

In an embodiment in which the optical module 200 is implemented as an image sensor module, the image sensor module may be disposed on the carrier 300 and may move along with the carrier 300 in the optical axis (Z-axis) direction.

The image sensor module 800 may be a device that converts light incident through a plurality of lenses into an electrical signal.

As an example, the image sensor module 800 may include an image sensor 810 and a printed circuit board 820 connected to the image sensor 810, and may further include an infrared filter.

An infrared filter may block light in an infrared region of light incident through the plurality of lenses.

The image sensor 810 may convert incident light into an electrical signal through the plurality of lenses 220. As a non-limited example, the image sensor 810 may be implemented as a charge coupled device (CCD) or a complementary metal-oxide semiconductor (CMOS).

An electrical signal converted by the image sensor 810 may be output as an image through a display device of a portable electronic device.

The image sensor 810 may be fixed to the printed circuit board 820 and may be electrically connected to the printed circuit board 820 by wire bonding.

In an example, the image sensor module 800 may be disposed in a lower portion of the housing 120.

The case 110 may be coupled to the housing 120 to surround an external surface of the housing 120, and may operate to protect internal components of the camera module 1.

In an embodiment, the camera module 1 may include the first driving unit 500. The first driving unit 500 may be configured to generate a driving force to move the optical module 200 in the optical axis (Z-axis) direction.

In an example, the first driving unit 500 may move the carrier 300 by generating a driving force in the optical axis (Z-axis) direction. Since the optical module 200 may be disposed in the carrier 300, the carrier 300 and the optical module 200 may move together in the optical axis (Z-axis) direction based on the driving force of the first driving unit 500.

The first driving unit 500 may include a first magnet 510 and a first coil 530. The first magnet 510 and the first coil 530 may be disposed to face each other in a direction (e.g., in the second axis (Y-axis) direction) perpendicular to the optical axis (Z-axis).

The first magnet 510 may be mounted on the carrier 300. As an example, the first magnet 510 may be mounted on one side surface of the carrier 300.

The first magnet 510 may be magnetized such that one surface (e.g., the surface facing the first coil 530) may have both an N-pole and an S-pole. For example, an N-pole, a neutral region, and an S-pole may be provided on one surface of the first magnet 510 that faces the first coil 530 in order in the optical axis (Z-axis) direction.

The first coil 530 may be disposed to face the first magnet 510. In an example, the first coil 530 may be disposed to face the first magnet 510 in the second axis (Y-axis) direction.

The first coil 530 may be disposed on the substrate 900, and the substrate 900 may be mounted on the housing 120 such that the first magnet 510 and the first coil 530 may face each other in the second axis (Y-axis) direction. In an example, the first coil 530 may be disposed on one internal side surface of the substrate 900.

The housing 120 may include an opening that penetrates a side surface of the housing 120, and the first coil 530 disposed on the substrate 900 may directly face the first magnet 510 through the opening.

The first magnet 510 may be a moving member that is mounted on the carrier 300 and moves in the optical axis (Z-axis) direction together with the carrier 300, and the first coil 530 may be a fixed member fixed to the substrate 900.

When power is applied to the first coil 530, the carrier 300 may move in the optical axis (Z-axis) direction based on an electromagnetic force between the first magnet 510 and the first coil 530.

Since the optical module 200 is accommodated in the carrier 300, the optical module 200 may also move in the optical axis (Z-axis) direction by movement of the carrier 300.

The first ball member B1 (BG1 and BG2) may be disposed between the carrier 300 and the housing 120. In an example, the first ball member B1 may be disposed between the carrier 300 and the housing 120 and may reduce friction when the carrier 300 moves.

The first ball member B1 may include a plurality of balls. The plurality of balls may move in the optical axis (Z-axis) direction when the carrier 300 moves in the optical axis (Z-axis) direction.

A first yoke 570 may be disposed in the housing 120. The first yoke 570 may be disposed in a position facing the first magnet 510. For example, the first coil 530 may be disposed on one internal side surface of the substrate 900, and the first yoke 570 may be disposed on one external side surface (for example, an opposite side of one internal side surface) of the substrate 900.

The first magnet 510 and the first yoke 570 may generate an attractive force therebetween. In an example, the first yoke 570 may be a magnetic material. An attractive force may act between the first magnet 510 and the first yoke 570 in a direction (for example, in the second axis (Y-axis) direction) perpendicular to the optical axis (Z-axis).

The first ball member B1 (BG1 and BG2) may be in contact with each of the carrier 300 and the housing 120 based on an attractive force between the first magnet 510 and the first yoke 570.

The first ball member B1 may include a first ball group BG1 and a second ball group BG2. The first ball group BG1 and the second ball group BG2 may be spaced apart from each other in a direction (e.g., the first axis (X-axis) direction) perpendicular to the optical axis (Z-axis). In a non-limited example, the first ball group BG1 may include two or more balls disposed in the optical axis (Z-axis) direction. In an example, the number of balls included in the second ball group BG2 may be less than the number of balls included in the first ball group BG1.

In an example, the first ball group BG1 may include two or more balls disposed in the optical axis (Z-axis) direction, and the second ball group BG2 may have fewer balls than the number of balls included in the first ball group BG1. The number of balls included in each ball member may vary under the premise that the number of balls included in the first ball group BG1 and the number of balls included in the second ball group BG2 are different.

In the description below, for ease of description, the first ball group BG1 may include three balls, and the second ball group BG2 may include two balls.

Among the three balls included in the first ball group BG1, two balls disposed on an outermost side in the optical axis (Z-axis) direction may have the same diameter, and a diameter of one ball disposed therebetween may be smaller than those of the balls disposed on an outermost side.

In a non-limited example, the two balls included in the second ball group BG2 may have the same diameter. The example that components have the same diameter may include the configuration in which the components physically have the same diameter, and may also include manufacturing errors.

A distance between centers of balls disposed on an outermost side in the optical axis (Z-axis) direction among the plurality of balls included in the first ball group BG1, and a distance between centers of balls disposed on the outermost side in a direction parallel to the optical axis (Z-axis) among the plurality of balls included in the second ball group BG2 may be different.

Referring to FIGS. 3 and 4, a first guide groove 310 and a second guide groove 320 may be respectively disposed on the carrier 300 and the housing 120.

In an example, the first guide groove 310 and the second guide groove 320 may be disposed on surfaces on which the carrier 300 and the housing 120 face each other, respectively. The first guide groove 310 and the second guide groove 320 may be spaced apart from each other in the first axis (X-axis) direction. The first guide groove 310 and the second guide groove 320 may extend in the optical axis (Z-axis) direction.

The first guide groove 310 of the carrier 300 and the first guide groove 310 of the housing 120 may face each other in the second axis (Y-axis) direction. Additionally, the second guide groove 320 of the carrier 300 and the second guide groove 320 of the housing 120 may face each other in the second axis (Y-axis) direction.

In an example, the first ball group BG1 may be disposed between the first guide groove 310 of the carrier 300 and the first guide groove 310 of the housing 120. Additionally, the second ball group BG2 may be disposed between the second guide groove 320 of the carrier 300 and the second guide groove 320 of the housing 120.

Among the plurality of balls included in the first ball group BG1, the balls disposed on an outermost side in the optical axis (Z-axis) direction may be in two-point contact with the first guide groove 310 of the carrier 300 and may be in two-point contact with the first guide groove 310 of housing 120.

The first ball group BG1, the first guide groove 310 of the carrier 300 and the first guide groove 310 of the housing 120 may operate as a main guide to guide a movement of the carrier 300 in the optical axis (Z-axis) direction.

When the second ball group BG2 includes a plurality of balls, the balls disposed on the outermost side in the optical axis (Z-axis) direction among the plurality of balls included in the second ball group BG2 may be in one-point contact with the second guide groove 320 of the carrier 300, and may be in two-point contact with the second guide groove 320 of the housing 120 (and vice versa).

When the second ball group BG2 includes one ball, one ball may be in two-point contact with one of the second guide groove 320 of the carrier 300 and the second guide groove 320 of the housing 120 and may be in one-point contact with the other.

The second ball group BG2, the second guide groove 320 of the carrier 300 and the second guide groove 320 of the housing 120 may operate as auxiliary guides supporting movement of the carrier 300 in the optical axis (Z-axis) direction.

To move the carrier 300 parallel to the optical axis (Z-axis) direction (i.e., prevent tilting from occurring) when the carrier 300 moves in the optical axis (Z-axis) direction, the center point CP of the attractive force between the first magnet 510 and the first yoke 570 should be disposed in the support region A connecting contact points of the first ball member B1 and the carrier 300 (or housing 120) to each other.

When the center point CP of the attractive forces deviates from the support region A, a position of the carrier 300 may be shifted during movement of the carrier 300, such that tilting may occur. Accordingly, it may be necessary to configure the support region A to be relatively wide.

In an embodiment, a size (e.g., diameter) of a portion of the plurality of balls of the first ball member B1 may be intentionally configured to be smaller than a size (e.g., diameter) of the other balls. In this example, the larger ball (or balls) among the plurality of balls may be intentionally in contact with the carrier 300 (or the housing 120).

Since the diameter of two balls among three balls in the first ball group BG1 is larger than the diameter of the other ball, the two balls in the first ball group BG1 may be in contact with the carrier 300 and the housing 120, respectively. Additionally, since the two balls of the second ball group BG2 have the same diameter, two balls of the second ball group BG2 may be in contact with the carrier 300 and the housing 120, respectively.

Accordingly, as illustrated in FIG. 3, when viewed in the second axis (Y-axis) direction, the first ball member B1 may be in four-point contact with the carrier 300 (or housing 120). Additionally, the support region A that connects contact points may have a quadrangular shape (e.g., a trapezoid).

Accordingly, the support region A may be formed relatively wide, and accordingly, the center point CP of attractive forces acting between the first magnet 510 and the first yoke 570 may be stably disposed in the support region A. Accordingly, driving stability during focus adjustment may be ensured.

Even when the two balls of the second ball group BG2 are manufactured to have the same diameter, the two balls of the second ball group BG2 may not have completely the same diameter physically due to manufacturing errors. In this example, one of the two balls of the second ball group BG2 can be in contact with the carrier 300 (or the housing 120).

Accordingly, the support region A that connects the contact points at which the first ball member B1 is in contact with the carrier 300 (or housing 120) may have a triangular shape.

Even when support region A is triangular, the support region A may be formed widely by the balls disposed on an outermost side in the optical axis (Z-axis) direction among the three balls of the first ball group BG1, such that driving stability during focus adjustment can be ensured.

Apart from ensuring driving stability during focus adjustment, reducing a height (i.e., slimming) of the camera module 1 in the optical axis (Z-axis) direction may also be an important issue. By simply reducing the height of the camera module 1 in the optical axis (Z-axis) direction, the height of the support region A in the optical axis (Z-axis) direction may also be reduced.

In other words, by simply reducing the height of the camera module 1 in the optical axis (Z-axis) direction, driving stability may deteriorate during focus adjustment.

In an embodiment, an auxiliary yoke 590 may be disposed in a position facing the first magnet 510. In an example, the auxiliary yoke 590 may be disposed on the substrate 900 to face the first magnet 510.

The auxiliary yoke 590 may be disposed closer to a main guide than an auxiliary guide. In an example, the auxiliary yoke 590 may be disposed closer to the first ball group BG1 than to the second ball group BG2. The auxiliary yoke 590 may be disposed closer to the first guide groove 310 than the second guide groove 320. The auxiliary yoke 590 may be a material which may generate an attractive force for the first magnet 510.

Accordingly, an attractive force acting between the first magnet 510 and the first yoke 570, and a resultant force of the attractive force acting between the first magnet 510 and the auxiliary yoke 590 may be disposed closer to the main guide than the auxiliary guide.

In another embodiment, the first magnet 510 on a side surface of the carrier 300 may be disposed eccentrically to one side of the first magnet 510 in the length direction (e.g., first axis (X-axis) direction).

A center of a side surface of the carrier 300 and a center of the first magnet 510 may be shifted from each other. The direction in which the first magnet 510 is eccentric may be toward the main guide.

In an example, the first magnet 510 may be disposed closer to the main guide than the auxiliary guide.

Since the support region A may be closer to the main guide, the length in the optical axis (Z-axis) direction may increase, by disposing the first magnet 510 closer to the main guide, the center point CP of attractive force can be disposed in the support region A stably.

In an embodiment, by configuring a length of the first guide groove 310 corresponding to the main guide in the optical axis (Z-axis) direction to be longer than the length of the second guide groove 320 corresponding to the auxiliary guide in the optical axis (Z-axis) direction, the size of the support region A may increase.

In other words, by configuring the lengths of the space in the optical axis (Z-axis) direction in which each ball group is accommodated differently, the size of the support region A may be prevented from changing, or even when the size of the support region A is changed, the center point CP of attractive force may not deviate from the support region A.

Referring to FIG. 4, a first support portion 121 and a second support portion 122 may be disposed in the housing 120. For example, the first support portion 121 and the second support portion 122 may protrude from an inner bottom surface of the housing 120 in the optical axis (Z-axis) direction.

The first support portion 121 may protrude in the optical axis (Z-axis) direction toward the first ball group BG1, and the second support portion 122 may protrude in the optical axis (Z-axis) direction toward the second ball group BG2.

In a non-limited example, a length of the second support portion 122 in the optical axis (Z-axis) direction may be longer than a length of the first support portion 121 in the optical axis (Z-axis) direction.

In an embodiment, the camera module 1 may sense a position of the carrier 300 in the optical axis (Z-axis) direction.

Accordingly, the first position sensor 550 may be provided. The first position sensor 550 may be disposed on the substrate 900 to face the first magnet 510. In an example, the first position sensor 550 may be a Hall sensor.

The camera module 1 may correct shaking during imaging by moving the optical module 200 in a direction perpendicular to the optical axis (Z-axis). To this end, the camera module 1 may include a second driving unit 600 that moves the optical module 200 in a direction perpendicular to the optical axis (Z-axis).

Additionally, in an embodiment in which the optical module 200 is implemented as an image sensor module, the image sensor module may move in a direction perpendicular to the optical axis (Z-axis).

The guide frame 400 and the optical module 200 may be sequentially accommodated in the carrier 300. For example, a guide frame 400 may be disposed between the carrier 300 and the optical module 200. When viewed from the optical axis (Z-axis) direction, the guide frame 400 may have a quadrangular shape of which two sides are removed. For example, the guide frame 400 may have a ‘7’ or ‘L’ shape when viewed from the optical axis (Z-axis) direction.

The guide frame 400 and the optical module 200 may move together in one direction perpendicular to the optical axis (Z-axis) based on a driving force of the second driving unit 600, and the optical module 200 may move relative to the guide frame 400 in another direction perpendicular to the optical axis (Z-axis).

For example, the guide frame 400 and the optical module 200 may move together in the first axis (X-axis) direction perpendicular to the optical axis (Z-axis) direction, and the optical module 200 may move relative to the guide frame 400 in the second axis (Y-axis) direction perpendicular to both the optical axis (Z-axis) direction and the first axis (X-axis) direction.

The optical module 200 may further include a holder 230 coupled to the lens barrel 210. The lens barrel 210 and the holder 230 may be coupled to each other and may move together.

The second driving unit 600 may generate a driving force in a direction perpendicular to the optical axis (Z-axis). In an embodiment, the second driving unit 600 may generate a driving force in the first axis (X-axis) direction and the second axis (Y-axis) direction.

The second driving unit 600 may include one or more magnets 611, 631, and a plurality of coils 613, 633. The plurality of coils 613, 633 may be disposed to face one or more magnets 611, 631. In an embodiment, one or more magnets may be disposed on a side surface of the optical module 200. One of the plurality of coils may face one polarity of one or more magnets, and the other one of the plurality of coils may face two polarities of one or more magnets.

In an embodiment, the one or more magnets may include a second magnet 611 and a third magnet 631. Additionally, the plurality of coils may include a second coil 613 and a third coil 633.

The second magnet 611 and the second coil 613 may be disposed to face each other in the first axis (X-axis) direction.

The second magnet 611 may be disposed on the optical module 200. For example, the second magnet 611 may be mounted on a side surface of the holder 230.

The second magnet 611 may be magnetized such that one surface (e.g., the surface facing the second coil 613) has one polarity. For example, one surface of second magnet 611 may have an N-pole or an S-pole. The other surface of the second magnet 611 may be magnetized to have an opposite polarity to a polarity of one surface of the second magnet 611.

The second magnet 611 may have a shape having a length in the second axis (Y-axis) direction.

The second coil 613 may be disposed to face the second magnet 611. For example, the second coil 613 may be disposed to face the second magnet 611 in the first axis (X-axis) direction. In an example, the second coil 613 may have a toroid shape having a hollow portion.

The second coil 613 may be disposed to face one polarity of one surface of the second magnet 611.

During image stabilization, the second magnet 611 may be a moving member that is mounted on the optical module 200, and the second coil 613 may be a fixed member fixed to the housing 120.

When power is applied to the second coil 613, the optical module 200 and the guide frame 400 may move in the first axis (X-axis) direction based on an electromagnetic force between the second magnet 611 and the second coil 613.

The second magnet 611 and the second coil 613 may generate a driving force in the direction (e.g., first axis (X-axis) direction) in which the second magnet 611 and the second coil 613 face each other.

The third magnet 631 and the third coil 633 may be disposed to face each other in the first axis (X-axis) direction.

The third magnet 631 may be disposed on the optical module 200. For example, the third magnet 631 may be mounted on a side surface of the holder 230. That is, in the embodiment, both the second magnet 611 and the third magnet 631 may be disposed on a side surface of the holder 230.

The second magnet 611 and the third magnet 631 may be spaced apart from each other in the second axis (Y-axis) direction.

The third magnet 631 may be magnetized such that one surface (e.g., the surface facing the third coil 633) may have one polarity. For example, one surface of the third magnet 631 may have an N-pole or an S-pole. The other surface of the third magnet 631 may be magnetized to have a polarity opposite to a polarity of one surface of the third magnet 631.

Additionally, the polarity of one surface of the second magnet 611 and the polarity of one surface of the third magnet 631 may be opposite to each other.

The third coil 633 may be disposed to face one polarity of one surface of the third magnet 631.

Additionally, the third coil 633 may be disposed to face the second magnet 611.

In other words, the third coil 633 may be disposed to face the second magnet 611 and the third magnet 631.

For example, one portion of the third coil 633 may face the second magnet 611 in the first axis (X-axis) direction, and the other portion of the third coil 633 may face the third magnet 631 in the first axis (X-axis) direction.

The polarity of one surface of the second magnet 611 facing one portion of the third coil 633 may be opposite to the polarity of one surface of the third magnet 631 facing the other portion of the third coil 633.

In an example, the third coil 633 may have a toroid shape having a hollow portion.

A length of the second magnet 611 in the second axis (Y-axis) direction may be longer than a length of the third magnet 631 in the second axis (Y-axis) direction.

The second coil 613 and the third coil 633 may be provided on a substrate 900. As an example, the second coil 613 and the third coil 633 may be disposed on the other internal side surface of the substrate 900.

The substrate 900 may be mounted on the side surface of the housing 120, and the second coil 613 may directly face the second magnet 611 through an opening provided in the housing 120, and the third coil 633 may be connected to the second magnet 611 and the third magnet 631.

The first coil 530 of the first driving unit 500 may be disposed on one internal side surface of the substrate 900.

One internal side surface of the substrate 900 may be coupled to a side surface of the housing 120, and another internal side surface of the substrate 900 may be coupled to the other side surface of the housing 120.

In other words, the substrate 900 may be mounted on two side surfaces of the housing 120. The two side surfaces of the housing 120 may be perpendicular to each other.

Additionally, the second ball group BG2 of the first ball member B1 may be disposed in an edge region in which two side surfaces (a side surface and the other side surface) of the housing 120 are connected to each other. Accordingly, the substrate 900 may be mounted on two side surfaces of the housing 120 to surround the second ball group BG2.

During image stabilization, the third magnet 631 may be a moving member that is mounted on the optical module 200, and the third coil 633 may be a fixed member fixed to the housing 120.

When power is applied to the third coil 633, the optical module 200 may move in the second axis (Y-axis) direction based on an electromagnetic force between the second magnet 611 and third magnet 631 and the third coil 633.

The second magnet 611 and the third magnet 631, and the third coil 633 may generate a driving force in a direction (e.g., the second axis (Y-axis) direction) perpendicular to the direction (e.g., first axis (X-axis) direction) in which the second magnet 611 and the third magnet 631 face each other.

The second magnet 611 and the third magnet 631 may be spaced apart from each other in the second axis (Y-axis) direction, and the second coil 613 and the third coil 633 may also be spaced apart from each other in the second axis (Y-axis) direction.

In the embodiment, both the second magnet 611 and the third magnet 631 may be disposed on a side surface of the optical module 200, and both the second coil 613 and the third coil 633 may be disposed on a side surface of the housing 120. That is, since the second driving unit 600 that generates a driving force in two directions perpendicular to each other may be disposed on a side surface of the housing 120 and a side surface of the optical module 200 facing each other, the size of the camera module 1 may be reduced.

In an embodiment, the camera module 1 may include a plurality of ball members that support a guide frame 400 and an optical module 200. The plurality of ball members may operate to guide a movement of the guide frame 400 and the optical module 200 during an image stabilization process, and may also operate to maintain a distance between the carrier 300, the guide frame 400 and the optical module 200.

The plurality of ball members may include a second ball member B2 and a third ball member B3.

The second ball member B2 may guide a movement of the guide frame 400 and the optical module 200 in the first axis (X-axis) direction, and the third ball member B3 may guide a movement of the optical module 200 in the second axis (Y-axis) direction.

In an example, the second ball member B2 may roll in the first axis (X-axis) direction when a driving force occurs in the first axis (X-axis) direction. Accordingly, the second ball member B2 may guide a movement of the guide frame 400 and the optical module 200 in the first axis (X-axis) direction.

Third ball member B3 may roll in the second axis (Y-axis) direction when a driving force in the second axis (Y-axis) direction occurs. Accordingly, the third ball member B3 may guide a movement of the optical module 200 in the second axis (Y-axis) direction.

The second ball member B2 may include a plurality of balls disposed between the carrier 300 and the guide frame 400, and the third ball member B3 may include a plurality of balls disposed between the guide frame 400 and the optical module 200.

In a non-limited example, each of the second ball member B2 and the third ball member B3 may include three balls.

A third guide groove 410 that accommodates the second ball member B2 may be formed on at least one of surfaces on which the carrier 300 and the guide frame 400 face each other in the optical axis (Z-axis) direction. The third guide groove 410 may include a plurality of grooves corresponding to the plurality of ball members of the second ball member B2.

The second ball member B2 may be accommodated in the third guide groove 410 and may be inserted between the carrier 300 and the guide frame 400.

While the second ball member B2 is accommodated in the third guide groove 410, movement thereof in the optical axis (Z-axis) direction and the second axis (Y-axis) direction is limited, and the second ball member B2 may move only in the first axis (X-axis) direction. For example, the second ball member B2 may roll only in the first axis (X-axis) direction.

Accordingly, a plane shape of each of a plurality of grooves of the third guide groove 410 may be a rectangular shape having a length in the first axis (X-axis) direction.

A fourth guide groove 420 that accommodates the third ball member B3 may be formed on at least one of surfaces on which the guide frame 400 and the optical module 200 face each other in the optical axis (Z-axis) direction. The fourth guide groove 420 may include a plurality of grooves corresponding to the plurality of ball members of the third ball member B3.

The third ball member B3 may be accommodated in the fourth guide groove 420 and may be inserted between the guide frame 400 and the optical module 200.

While the third ball member B3 is accommodated in the fourth guide groove 420, movement thereof in the optical axis (Z-axis) direction and the first axis (X-axis) direction may be limited, and the third ball member B3 may move only in the second axis (Y-axis) direction. For example, the third ball member B3 may roll only in the second axis (Y-axis) direction.

Accordingly, a plane shape of each of a plurality of grooves of the fourth guide groove 420 may be a quadrangular shape having a length in the second axis (Y-axis) direction.

When a driving force occurs in the first axis (X-axis) direction, the guide frame 400 and the optical module 200 may move together in the first axis (X-axis) direction. In an example, the second ball member B2 may roll along the first axis (X-axis). In this example, movement of the third ball member B3 may be limited.

Additionally, when a driving force occurs in the second axis (Y-axis) direction, the optical module 200 may move relative to the guide frame 400 in the second axis (Y-axis) direction. In an example, the third ball member B3 may roll along the second axis (Y-axis). In this example, a movement of the second ball member B2 may be limited.

In embodiments, the second yoke 730 may be provided such that the carrier 300 and the guide frame 400 may maintain to be in contact with the second ball member B2, and the optical module 200 and the guide frame 400 may maintain to be in contact with the third ball member B3.

The second yoke 730 may be disposed to be fixed to the carrier 300 and to face one or more of the second magnet 611 and the third magnet 631 in the optical axis (Z-axis) direction.

An attractive force may be generated between the second yoke 730 and the second magnet 611 and/or the third magnet 631 in the optical axis (Z-axis) direction.

Since the optical module 200 and the guide frame 400 are pressed in a direction toward the second yoke 730 by an attractive force between the second yoke 730 and the second magnet 611 and/or the third magnet 631, the guide frame 400 and the optical module 200 can be maintained to be in contact with the second ball member B2 and the third ball member B3.

In embodiments, both the second magnet 611 and the third magnet 631 may be disposed on one side surface of the optical module 200, such that an attractive force generated from a region with the second yoke 730 may be shifted to one side. In this example, it may be difficult for the second ball member B2 and the third ball member B3 to maintain to be in contact with an object. Additionally, an attractive force between the second yoke 730, the second magnet 611 and/or the third magnet 631 may be insufficient.

Accordingly, in an embodiment, the camera module 1 may further include a pulling magnet 710. The pulling magnet 710 may be disposed on the optical module 200. In an example, the pulling magnet 710 may be disposed on a second side surface of the optical module 200 perpendicular to a first side surface of the optical module 200.

Additionally, the third yoke 750 may be disposed in a position facing the pulling magnet 710 in the optical axis (Z-axis) direction.

The third yoke 750 may be fixed to the carrier 300. An attractive force may be generated between the third yoke 750 and the pulling magnet 710 in the optical axis (Z-axis) direction. The second yoke 730 and the third yoke 750 may be magnetic materials.

In an embodiment, the camera module 1 may sense a position of the optical module 200 in a direction perpendicular to the optical axis (Y-axis).

Accordingly, the second position sensor 615 and the third position sensor 635 may be provided. Each of the second position sensor 615 and the third position sensor 635 may be disposed on the substrate 900. The second position sensor 615 and the third position sensor 635 may be spaced apart from each other in the second axis (Y-axis) direction.

The second position sensor 615 may be disposed to face a first polarity (N-pole or S-pole) of the second magnet 611. The third position sensor 635 may be disposed to face the first polarity (N or S-pole) of the second magnet 611 and a second polarity (S-pole or N-pole) of the third magnet 631.

The first polarity and the second polarity may be opposite polarities.

One of the second position sensor 615 and the third position sensor 635 may include one Hall sensor, and the other may include a plurality of Hall sensors.

In an example, the second position sensor 615 may include one Hall sensor facing the first polarity of the second magnet 611. The third position sensor 635 may include a plurality of Hall sensors. In an example, the third position sensor 635 may include two Hall sensors. In an example, one of the two Hall sensors may be disposed close to the first polarity of the second magnet 611, and the other of the two Hall sensors may be disposed close to the second polarity of the third magnet 631.

When the optical module 200 moves in the first axis (X-axis) direction, a distance between the second magnet 611 and the second position sensor 615 in the first axis (X-axis) direction may decrease or increase. Accordingly, the second position sensor 615 may sense a position of the optical module 200 in the first axis (X-axis) direction.

When the optical module 200 moves in the second axis (Y-axis) direction, the third position sensor 635 may move closer to the first polarity of the second magnet 611 and may move away from the second polarity of the third magnet 631. Alternatively, the third position sensor 635 may move away from the first polarity of the second magnet 611 and may move closer to the second polarity of the third magnet 631. Accordingly, the third position sensor 635 may sense a position of the optical module 200 in the second axis (Y-axis) direction.

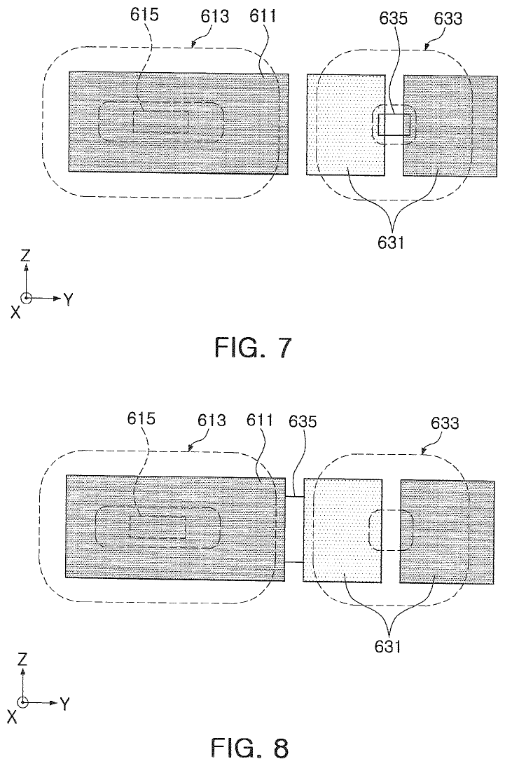

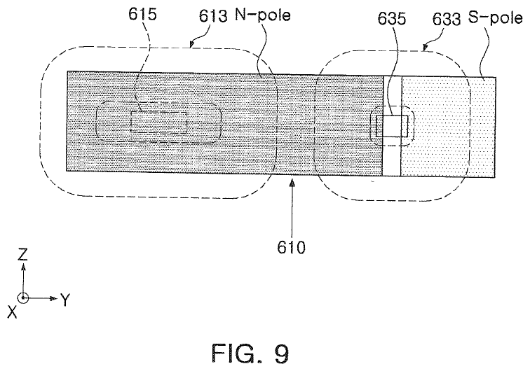

FIGS. 7 to 9 are diagrams illustrating modified examples of a second driving unit.

First, referring to FIG. 7, the second driving unit 600 may include a second magnet 611 and a second coil 613 facing each other, and a third magnet 631 and a third coil 633 facing each other.

One surface of the second magnet 611 facing the second coil 613 may have one polarity, and one surface of the third magnet 631 facing the third coil 633 may have two polarities.

In an example, the second coil 613 may face the N-pole of one surface of the second magnet 611, and the third coil 633 may face the N and S-poles of one surface of the third magnet 631.

On one surface of the third magnet 631, the N-pole and S-pole may be magnetized in the second axis (Y-axis) direction.

The second magnet 611 and the second coil 613 may generate a driving force in a direction (the first axis (X-axis) direction) in which the second magnet 611 and the second coil 613 face each other, and the third magnet 631 and the third coil 633 may generate a driving force in a direction perpendicular to the direction (the second axis (Y-axis) direction) in which the third magnet 631 and the third coil 633 face each other.

Referring to FIG. 8, differently from the embodiment illustrated in FIG. 7, there may be a difference in the position of the third position sensor 635.

The third position sensor 635 may be disposed between the second coil 613 and the third coil 633. In an example, the third position sensor 635 may include a plurality of Hall sensors.

When the optical module 200 moves in the second axis (Y-axis) direction, the third position sensor 635 may move closer to the first polarity (e.g., N-pole) of the second magnet 611, and may move away from the second polarity (e.g., S-pole) of the third magnet 631. Alternatively, the third position sensor 635 may move away from the first polarity of the second magnet 611 and may move closer to the second polarity of the third magnet 631. Accordingly, the third position sensor 635 may sense the position of the optical module 200 in the second axis (Y-axis) direction.

Referring to FIG. 9, the second driving unit 600 may include one magnet 610 and a plurality of coils. The plurality of coils may be provided as the second coil 613 and the third coil 633.

The second coil 613 and the third coil 633 may be disposed to face the magnet 610.

In an embodiment, a portion of the magnet 610 may face the second coil 613 and the other portion of the magnet 610 may face the third coil 633.

One surface of the magnet 610 facing the second coil 613 and the third coil 633 may have a first polarity and a second polarity in the second axis (Y-axis) direction. The first polarity and the second polarity may be opposite polarities.

In an embodiment, one surface of the magnet 610 may have an N-pole, a neutral region, and an S-pole in the second axis (Y-axis) direction. The second coil 613 may face the N-pole of the magnet 610. Additionally, the third coil 633 may face the N and S-poles of the magnet 610.

An area occupied by the N-pole and the area occupied by the S-pole may be different on one surface of the magnet 610. In an example, an area of the N-pole may be larger than an area of the S-pole.

A length of the N-pole in the second axis (Y-axis) direction may be longer than a length of the S-pole in the second axis (Y-axis) direction.

According to the aforementioned embodiments, the camera module may have an image stabilization operation, and may have a reduced size.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a carrier disposed in the housing;
an optical module disposed on the carrier;
a first driving unit comprising a first magnet coupled to the carrier, and a first coil disposed to face the first magnet;
a second driving unit comprising one or more magnets coupled to a first side surface of the optical module, and a plurality of coils disposed to face the one or more magnets;
a first ball group and a second ball group disposed between the carrier and the housing, and spaced apart from each other in a first axis direction perpendicular to an optical axis direction; and
a substrate on which the first coil and the plurality of coils are disposed,
wherein a first of the plurality of coils faces one polarity of the one or more magnets, and a second of the plurality of coils faces two polarities of the one or more magnets,
wherein the first ball group comprises two or more balls disposed in the optical axis direction, and the second ball group comprises fewer balls than the first ball group, and
wherein the substrate is mounted on two side surfaces of the housing to surround the second ball group.

2. The camera module of claim 1,
wherein one surface of the one or more magnets which face an internal side surface of the substrate on which the plurality of coils are disposed has an N-pole and an S-pole, and
wherein the N-pole and the S-pole are disposed in a second axis direction perpendicular to both the optical axis direction and the first axis direction.

3. The camera module of claim 2, wherein a size of an area occupied by the N-pole is different from a size of an area occupied by the S-pole on the one surface of the one or more magnets.

4. The camera module of claim 2, wherein a first position sensor that faces the N-pole and a second position sensor that at least partially faces the N-pole and the S-pole are disposed on the substrate.

5. The camera module of claim 4, wherein the first position sensor comprises one Hall sensor and the second position sensor comprises a plurality of Hall sensors.

6. The camera module of claim 1,
wherein the one or more magnets comprise a second magnet and a third magnet spaced apart from each other in a second axis direction perpendicular to the optical axis direction and the first axis direction, and
wherein the plurality of coils comprise a second coil and a third coil spaced apart from each other in the second axis direction.

7. The camera module of claim 6, wherein a length of the second magnet in the second axis direction is greater than a length of the third magnet in the second axis direction.

8. The camera module of claim 6, wherein a first surface of the second magnet has one of an N-pole and an S-pole, and a first surface of the third magnet has an opposite polarity to a polarity of the first surface of the second magnet.

9. The camera module of claim 8,
wherein the second coil faces the first surface of the second magnet, and
wherein one portion of the third coil faces the first surface of the second magnet, and another portion of the third coil faces the first surface of the third magnet.

10. The camera module of claim 6,
wherein a first surface of the second magnet has a first polarity, and a first surface of the third magnet has a second polarity and a first polarity in the second axis direction, and
wherein the first polarity and the second polarity are opposite polarities.

11. The camera module of claim 10,
wherein a first position sensor that faces the first polarity of the second magnet and a second position sensor that at least partially faces the first polarity and the second polarity of the third magnet are disposed on the substrate, and
wherein the first position sensor comprises one Hall sensor, and the second position sensor comprises a plurality of Hall sensors.

12. The camera module of claim 10,
wherein a first position sensor that faces the first polarity of the second magnet and a second position sensor that at least partially faces the first polarity of the second magnet and the second polarity of the third magnet are disposed on the substrate, and
wherein the first position sensor comprises one Hall sensor, and the second position sensor comprises a plurality of Hall sensors.

13. The camera module of claim 1,
wherein one of the plurality of coils and the one or more magnets are configured to generate a driving force in a direction in which the one of the plurality of coils and the one or more magnets face each other, and
wherein another one of the plurality of coils and the one or more magnets are configured to generate a driving force in a direction perpendicular to the direction in which the other of the plurality of coils and the one or more magnets face each other.

14. The camera module of claim 1, further comprising:
a pulling magnet coupled to a second side surface of the optical module;
a first yoke that faces the one or more magnets in the optical axis direction; and
a second yoke that faces the pulling magnet in the optical axis direction.

15. A camera module, comprising:
a housing;
a carrier disposed in the housing;
a substrate disposed in the carrier;
an optical module disposed on the carrier;
a first driving unit comprising a first magnet coupled to the carrier, and a first coil disposed to face the first magnet;
a second driving unit comprising a second magnet and a third magnet coupled to a first side surface of the optical module, and a second coil and a third coil coupled to a first side of the substrate, and disposed to face the second magnet and the third magnet respectively;
a first position sensor, coupled to a second side of the substrate, and disposed to face the first magnet, and
a second position sensor and a third position sensor coupled to the first side of the substrate, and disposed to face the second magnet and the third magnet,
wherein the first driving unit is configured to move the optical module in an optical axis direction, and
wherein the second driving unit is configured to move the optical module in a first direction perpendicular to the optical axis direction and a second direction perpendicular to the optical axis direction and the first direction.
